(19) United States
(12) Patent Application Publication
(10) Pub. No.: US 2024/0152281 A1
(43) Pub. Date: May 9, 2024

(54) ARCHITECTURAL EXTENSIONS FOR MEMORY MIRRORING AT PAGE GRANULARITY ON DEMAND

(71) Applicant: Intel Corporation, Santa Clara, CA (US)

(72) Inventors: Qiuxu Zhuo, Shanghai (CN); Anthony Luck, San Jose, CA (US)

(73) Assignee: Intel Corporation, Santa Clara, CA (US)

(21) Appl. No.: 18/284,266

(22) PCT Filed: Jun. 22, 2021
(86) PCT No.: PCT/CN2021/101432

§ 371 Date: Sep. 26, 2023

(51) Int. Cl. G06F 3/06; G06F 12/06

(52) U.S. Cl. CPC G06F 3/0619; G06F 3/065; G06F 3/0673; G06F 12/0607; G06F 2212/1032

(57) ABSTRACT

An embodiment of an integrated circuit may comprise first circuitry to manage a memory in accordance with a page size and a channel interleave granularity, and second circuitry coupled to the first circuitry, the second circuitry to store data in a primary region of the memory at a primary address, and manage a mirror of the data in a secondary region of the memory at a secondary address at a regional granularity on demand at run time. Other embodiments are disclosed and claimed.

### BACKGROUND

### 1. Technical Field

This disclosure generally relates to processor technology, and memory mirroring technology.

### 2. Background Art

In the computer field, reliability, availability and serviceability (RAS) may refer to features or technology that are designed to provide robust computer hardware with high reliability, high availability, and ease of serviceability. Computers designed with higher levels of RAS may include features that protect data integrity, provide fault-tolerance, and/or provide uptime for relatively longer periods of time.

Memory mirroring is a technique used to separate memory into two separate channels, usually on a memory device, like a server, where one channel is copied to another channel to create data redundancy. Memory mirroring technology may provide higher memory reliability. For example, in the event of a memory failure in one channel, the system may remain operational because the memory controller can shift to the other channel without any disruption.

### BRIEF DESCRIPTION OF THE DRAWINGS

The various embodiments of the present invention are illustrated by way of example, and not by way of limitation, in the figures of the accompanying drawings and in which:

FIG. 1 is a block diagram of an example of an integrated circuit according to an embodiment;

FIGS. 2A to 2B are flow diagrams of an example of a method according to an embodiment;

FIG. 3 is a block diagram of an example of an apparatus according to an embodiment;

FIG. 4 is an illustrative diagram of an example of a memory space according to an embodiment;

FIGS. 5 to 7 are illustrative diagrams of respective example formats of page table entries according to embodiments;

FIG. 8 is an illustrative diagram of an example of a cache entry according to an embodiment;

FIG. 9 is an illustrative diagram of an example of a process flow according to an embodiment;

FIG. 10 is a block diagram of an example of a system according to an embodiment;

FIG. 11 is an illustrative diagram of another example of a process flow according to an embodiment;

FIGS. 12A to 12F are illustrative diagrams of respective examples of process flows according to embodiments;

FIG. 13 is an illustrative diagram of another example of a process flow according to an embodiment;

FIG. 14 is an illustrative diagram of another example of a process flow according to an embodiment;

FIGS. 15A to 15F are illustrative diagrams of respective examples of process flows according to embodiments;

FIG. 16 is a block diagram of an example of a logic circuit according to an embodiment;

FIG. 17 is an illustrative diagram of another example of a process flow according to an embodiment;

FIG. 18 is a block diagram of another example of a logic circuit according to an embodiment;

FIG. 19 is an illustrative diagram of another example of a process flow according to an embodiment;

FIG. 20 is a flow diagram of another example of a method according to an embodiment;

FIG. 21 is a flow diagram of another example of a method according to an embodiment;

FIG. 22 is a flow diagram of another example of a method according to an embodiment;

FIG. 23 is a flow diagram of another example of a method according to an embodiment;

FIG. 24 is an illustrative diagram of an example of a memory space according to an embodiment;

FIG. 25A is a block diagram illustrating both an exemplary in-order pipeline and an exemplary register renaming, out-of-order issue/execution pipeline according to embodiments of the invention.

FIG. 25B is a block diagram illustrating both an exemplary embodiment of an in-order architecture core and an exemplary register renaming, out-of-order issue/execution architecture core to be included in a processor according to embodiments of the invention;

FIGS. 26A-B illustrate a block diagram of a more specific exemplary in-order core architecture, which core would be one of several logic blocks (including other cores of the same type and/or different types) in a chip;

FIG. 27 is a block diagram of a processor that may have more than one core, may have an integrated memory controller, and may have integrated graphics according to embodiments of the invention;

FIGS. 28-31 are block diagrams of exemplary computer architectures; and

FIG. 32 is a block diagram contrasting the use of a software instruction converter to convert binary instructions in a source instruction set to binary instructions in a target instruction set according to embodiments of the invention.

### DETAILED DESCRIPTION

Embodiments discussed herein variously provide techniques and mechanisms for demand-based memory mirroring at a page granularity. The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide memory mirroring at page granularity on demand.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Some computer servers may include Reliability, Availability, and Serviceability (RAS) features targeted at limiting the impact of soft and hard errors in the memory system. Memory mirroring is one of the RAS features that enables memory devices having memory space designated for storing an extra copy of data in an alternate location in memory so that the data can be recovered if the primary data is uncorrectable. In conventional full channel mirroring, the total memory is split into two identical mirrors such that half of total memory needs to be reserved for redundancy. In conventional memory address range mirroring, only a subset of memory is mirrored and that subset must be setup at boot time. The fixed subset reduces the amount of memory reserved for redundancy, but the fixed subset is somewhat inflexible because the range of addresses is statically mirrored and needs a reboot of the system to take effect.

For full channel mirroring, for example, half of the memory controller channels store primary data, and the other half of the memory controller channels store redundant data (e.g., secondary data), which is redundant to the primary data. The total memory is split into two identical mirrors (primary and secondary). A problem with full channel mirroring is that half of the total memory is needed to provide the redundancy. Half of total memory is not reported in total system memory size for use. Memory may be wasted for redundancy for non-critical data/tasks, that doesn't need to be mirrored. Also, for full channel mirroring, the memory channel interleaving ways are reduced by half, thereby reducing available memory bandwidth.

Address range mirroring may be similar to full channel mirroring, but allows the BIOS/firmware/OS to statically determine a range of memory address to be mirrored, leaving the rest of memory non-mirrored. A problem with address range mirroring is that only a statically mirrored range of address are provided and the system needs to reboot for the mirrored range of addresses to take effect. For example, a Linux OS may need to be modified to negotiate with the BIOS/firmware for how much memory should be mirrored. With conventional address range mirroring, the amount of mirrored memory cannot be adjusted at run time, and a system reboot is required to change the amount (e.g., which may result in loss of system uptime). Also, similar to full channel mirroring, the memory channel interleaving ways for mirrored memory are also reduced by half for the mirrored range of addresses.

Some embodiments may overcome one or more of the foregoing problems with technology to extend a memory architecture to allow BIOS/firmware/operating system (OS)/tasks to setup/allocate/free mirrored memory at a page granularity on demand without a system reboot to take effect.

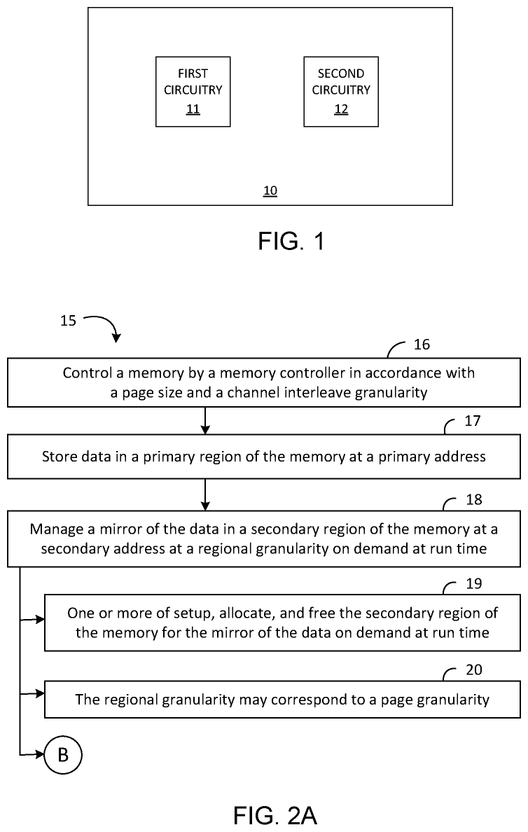

With reference to FIG. 1, an embodiment of an integrated circuit 10 may include first circuitry 11 to manage a memory in accordance with a page size and a channel interleave granularity, and second circuitry 12 coupled to the first circuitry 11. The second circuitry 12 may be configured to store data in a primary region of the memory at a primary address, and manage a mirror of the data in a secondary region of the memory at a secondary address at a regional granularity on demand at run time. For example, the second circuitry 12 may be configured to one or more of setup, allocate, and free the secondary region of the memory for the mirror of the data on demand at run time. In some embodiments, the regional granularity may correspond to a page granularity. The second circuitry 12 (e.g., and/or the first circuitry 11) may also be configured to adjust a total amount of mirrored memory on demand at run time. In some embodiments, the second circuitry 12 may be further configured to utilize a same number of interleaved ways for mirrored memory as a number of interleaved ways utilized for non-mirrored memory. For example, the second circuitry 12 may be configured to determine if the primary region is mirrored based on an indication stored in a page table entry (e.g., a “mirrored” (M) field, which may be 1-bit, 2-bits, etc.).

In some embodiments, the second circuitry 12 may be configured to calculate the secondary address to store the mirror of the data at an adjacent neighbor region of the primary region as a function of the primary address. For example, the function may provide a calculated address to a different memory channel from a memory channel of the primary address. In some embodiments, as explained in further detail herein, the function may be based on the primary address and the regional granularity (e.g., a page size). Additionally, or alternatively, the function may also be based on a number of interleaved channels and the channel interleave granularity.

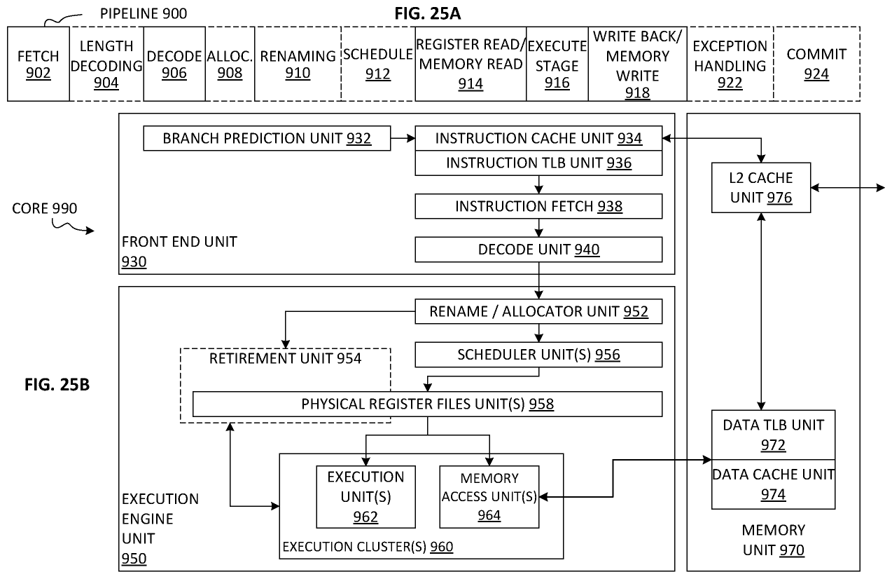

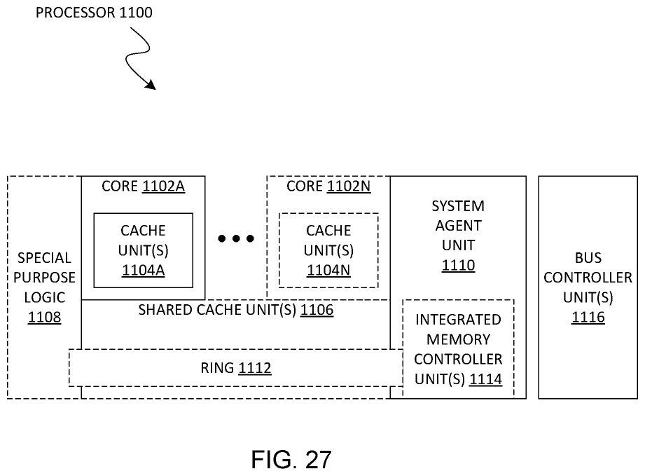

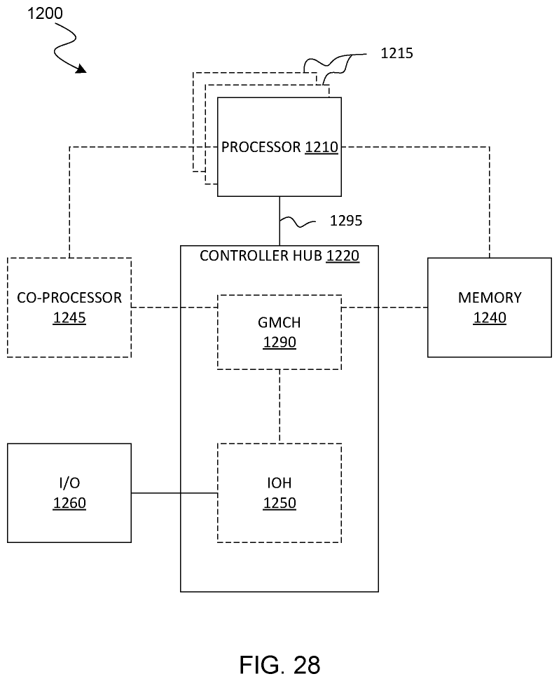

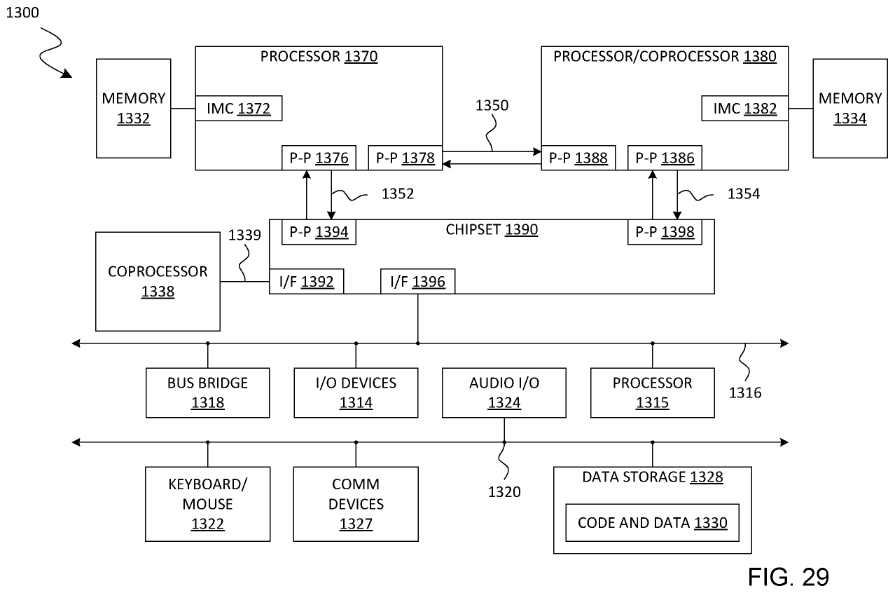

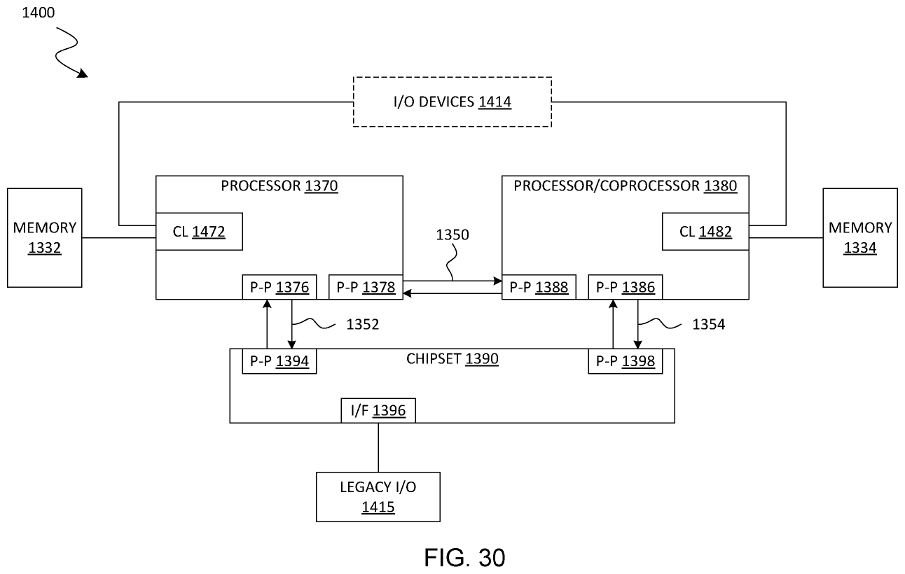

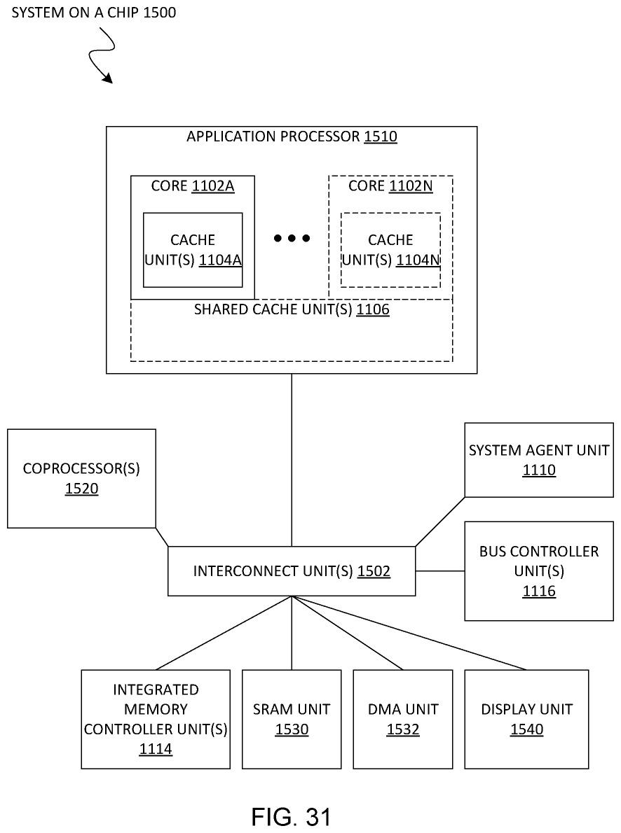

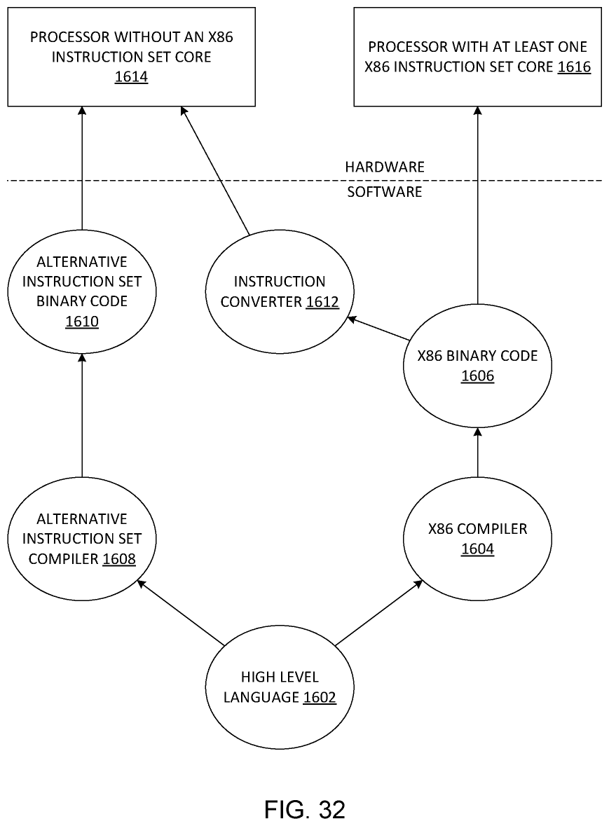

Embodiments of the integrated circuit 10 may be integrated with any useful processor or controller. Non-limiting examples of suitable processors include the core 990 (FIG. 25B), the cores 1102A-N (FIGS. 27, 31), the processor 1210 (FIG. 28), the co-processor 1245 (FIG. 28), the processor 1370 (FIGS. 29-30), the processor/coprocessor 1380 (FIGS. 29-30), the coprocessor 1338 (FIG. 29), the processor 1315 (FIG. 29), the coprocessor 1520 (FIG. 31), and/or the processors 1614, 1616 (FIG. 32). Non-limiting examples of suitable controllers include the integrated memory controller unit(s) 1114 (FIG. 27), the GMCH 1290 (FIG. 28), the IMCs 1372 and 1382 (FIG. 29), the chipset 1390 (FIGS. 29 and 30), the control logic 1472 and 1482 (FIG. 30), and the interconnect unit(s) 1502 (FIG. 31).

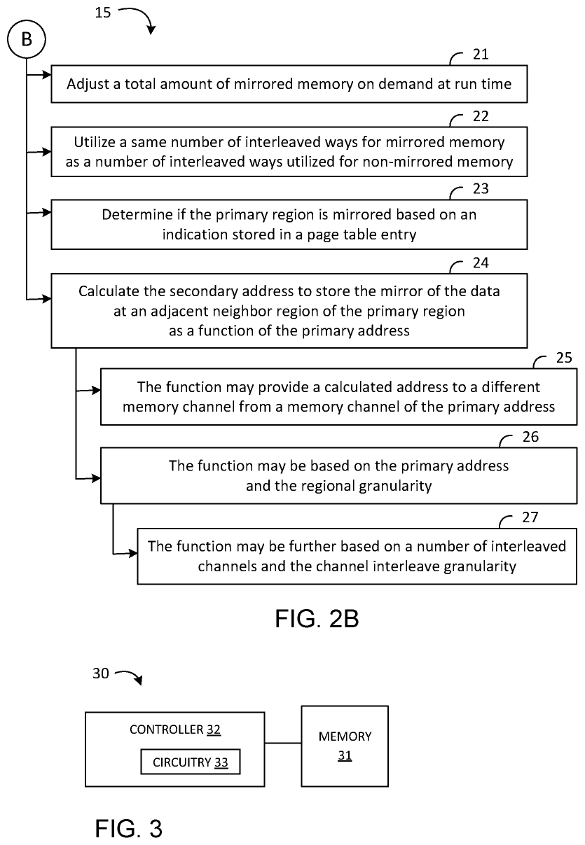

With reference to FIGS. 2A to 2B, an embodiment of a method 15 may include controlling a memory by a memory controller in accordance with a page size and a channel interleave granularity at box 16, storing data in a primary region of the memory at a primary address at box 17, and managing a mirror of the data in a secondary region of the memory at a secondary address at a regional granularity on demand at run time at box 18. For example, the method 15 may include one or more of setting up, allocating, and freeing the secondary region of the memory for the mirror of the data on demand at run time at box 19. In some embodiments, the regional granularity may correspond to a page granularity at box 20.

The method 15 may also include adjusting a total amount of mirrored memory on demand at run time at box 21, utilizing a same number of interleaved ways for mirrored memory as a number of interleaved ways utilized for non-mirrored memory at box 22, and/or determining if the primary region is mirrored based on an indication stored in a page table entry at box 23. Some embodiments of the method 15 may further include calculating the secondary address to store the mirror of the data at an adjacent neighbor region of the primary region as a function of the primary address at box 24. For example, the function may provide a calculated address to a different memory channel from a memory channel of the primary address at box 25. In some embodiments, the function may be based on the primary address and the regional granularity at box 26, and/or the function may be further based on a number of interleaved channels and the channel interleave granularity at box 27.

With reference to FIG. 3, an embodiment of an apparatus 30 may include memory 31, and a controller 32 communicatively coupled to the memory 31. The controller 32 may include circuitry 33 to manage the memory 31 in accordance with a page size and a channel interleave granularity, store data in a primary region of the memory 31 at a primary address, and manage a mirror of the data in a secondary region of the memory 31 at a secondary address at a regional granularity on demand at run time. For example, the circuitry 33 may be configured to one or more of setup, allocate, and free the secondary region of the memory 31 for the mirror of the data on demand at run time. In some embodiments, the regional granularity may correspond to a page granularity. The circuitry 33 may also be configured to adjust a total amount of mirrored memory on demand at run time. In some embodiments, the circuitry 33 may be further configured to utilize a same number of interleaved ways for mirrored memory as a number of interleaved ways utilized for non-mirrored memory. For example, the circuitry 33 may be configured to determine if the primary region is mirrored based on an indication stored in a page table entry (e.g., a M-field, a M-bit, etc.).

In some embodiments, the circuitry 33 may be configured to calculate the secondary address to store the mirror of the data at an adjacent neighbor region of the primary region as a function of the primary address. For example, the function may provide a calculated address to a different memory channel from a memory channel of the primary address. In some embodiments, as explained in further detail herein, the function may be based on the primary address and the regional granularity (e.g., a page size). Additionally, or alternatively, the function may also be based on a number of interleaved channels and the channel interleave granularity.

Embodiments of the memory 31 and controller 32 may be integrated with any useful processor or controller architecture. Non-limiting examples of suitable processors include the core 990 (FIG. 25B), the cores 1102A-N (FIGS. 27, 31), the processor 1210 (FIG. 28), the co-processor 1245 (FIG. 28), the processor 1370 (FIGS. 29-30), the processor/coprocessor 1380 (FIGS. 29-30), the coprocessor 1338 (FIG. 29), the processor 1315 (FIG. 29), the coprocessor 1520 (FIG. 31), and/or the processors 1614, 1616 (FIG. 32). Non-limiting examples of controllers that may include the circuitry 33 include the integrated memory controller unit(s) 1114 (FIG. 27), the GMCH 1290 (FIG. 28), the IMCs 1372 and 1382 (FIG. 29), the chipset 1390 (FIGS. 29 and 30), the control logic 1472 and 1482 (FIG. 30), and the interconnect unit(s) 1502 (FIG. 31).

Some embodiments may provide technology for architectural extensions for memory mirroring at a page granularity on demand. Memory with channel interleaving generally has a hardware property where consecutive memory blocks within a basic memory page are interleaved in different memory controller channels. A non-limiting example memory block may consist of 4 cache lines with 64 bytes per cache line. A non-limiting example basic memory page size may be 4096 bytes for a variety of OSes, tasks, and/or applications. Some embodiments utilize the memory interleave architecture of a memory to make memory blocks in a page (e.g., a primary page) and memory blocks in a corresponding neighbor page (e.g., a secondary page) contain the same data and interleave in different directions using a same interleaving rule. For example, the address to store the secondary data may calculated by a formula “secondary address=Function[primary address],” where the primary address is the address of the primary page and the secondary address is the calculated address of the secondary page.

In some embodiments, the primary data is mirrored by the secondary data in a different memory channel and the memory interleaving performance/ways is the same as a non-mirror mode. Advantageously, when only reading primary data (or reading secondary data if primary data is bad), the memory bandwidth is increased by about 100% compared to conventional mirroring technology (e.g., where the mirrored data is across fixed channels, all reads go to one channel, which reduces bandwidth otherwise provided by an interleaved memory architecture). Embodiments utilize the memory's interleaved architecture for better performance on read (e.g., write bandwidth remains the same). Some embodiments also makes the distribution of the primary and secondary read transactions be more even across channels. In some embodiments, a single M field in a page table entry (PTE) may be utilized to indicate that a page is mirrored by its neighbor page on demand (e.g., the M field in the PTE may be a single bit, or multiple bits). Advantageously, the total installed physical memory may be reported as total system memory for use and the mirrored memory may be setup/allocated/freed at a page granularity on demand without a system reboot to take effect.

Some embodiments may advantageously enhance a central processor unit (CPU) and/or a server by providing technology for a RAS feature to dynamically mirror data at a page granularity on demand and increase memory bandwidth by 100% when only reading primary data or reading secondary data if primary data becomes permanently bad. Some embodiments may also provide more flexible and more cost-effective memory mirroring technology as compared to conventional memory mirroring technology.

### Mirror Indication Bit(s) and Primary/Secondary Page

Some embodiments include mirror indication bit(s) or use some reserved bit(s), denoted herein as M, in a PTE, a translation lookaside buffer (TLB) entry, and an I/O TLB (IOTLB) entry to indicate that the corresponding page (e.g., primary page) starting at address P_ADDR with size P is mirrored by its adjacent page (e.g., secondary page) starting at address P_ADDR+P, with the same size P. If the primary page is cacheable, then the cache entries in caches for the primary page also carry the M indication bit(s). Cache lines are not allocated to store redundant data, so there aren't any cache entries in caches for any secondary pages. Because the primary page can be only mirrored by its adjacent page, the secondary address may be readily determined to store the secondary data when providing the primary address (e.g., as described in more detail below in connection with how to make primary/secondary data on different channels). A page without an associated mirrored page may be referred to herein as a normal page or a non-mirrored page.

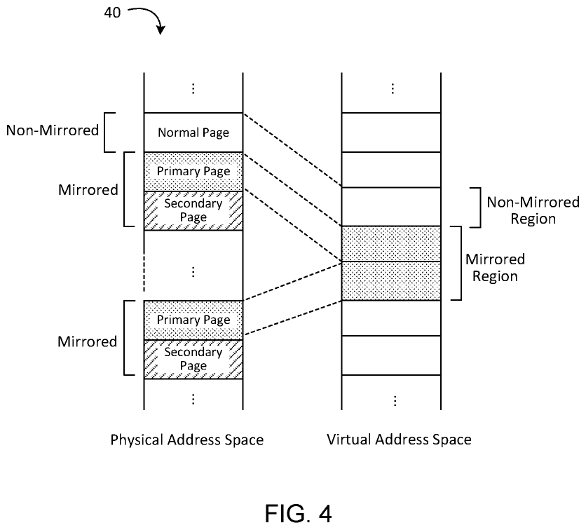

FIG. 4 shows an embodiment of a memory space 40. The memory space 40 includes physical primary/secondary pages in a physical address space and corresponding mirrored regions in a virtual address space. Physical addresses are contiguous, but hardware interleaving and selection of a secondary page size in accordance with embodiments described herein naturally pushes the secondary page to another memory channel.

### Examples of a Single M Bit in PTE and Double M Bits in Cache Entry

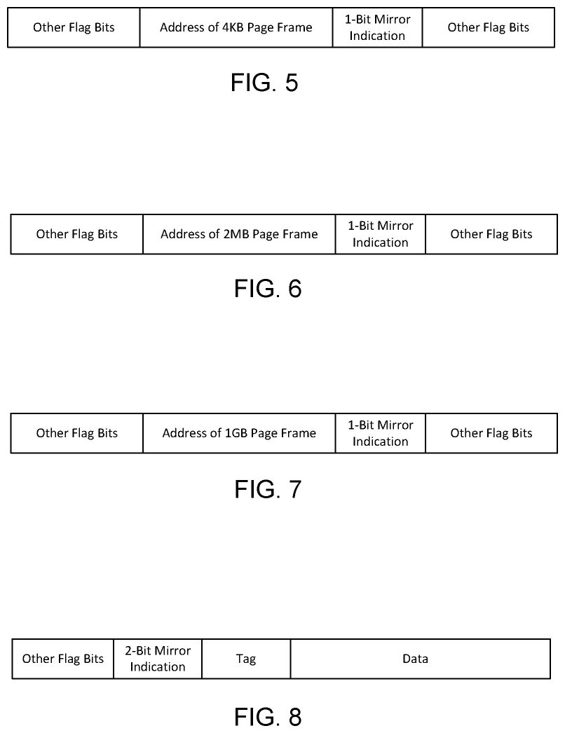

To minimize hardware overhead, in this embodiment, a single M bit in a PTE/TLB/IOTLB used to indicate a mirrored primary page is sufficient because the page size is already defined by the page table level. FIG. 5, FIG. 6, and FIG. 7 show example formats of PTEs with a 1-bit mirror indication M for a four kilobyte (4 KB) page, a two megabyte (2 MB) page, and a one gigabyte (1 GB) page respectively. When an OS needs a page to be mirrored by its adjacent page, the OS or BIOS/firmware sets the M bit in the PTE/TLB/IOTLB for the corresponding page.

Double M bits (2-bits) in a cache entry are used to keep track of the mirrored page size. FIG. 8 shows an example format of a cache entry with a 2-bit mirror indication M. Table 1 shows example encoding values of the 2-bit M cache entry for page sizes with 4 KB, 2 MB, and 1 GB for an example 64-bit processor architecture (e.g., INTEL X86F4). As indicated in Table 1, if the value of 2-bit M in a cache entry is 2, the data contained in the cache line is a part of a 2 MB mirrored primary page. When a CPU core issues a memory access with a virtual address, for example, a memory management unit (MMU) translates the virtual address to a physical address with the PTE. If the PTE indicates that the memory access is cacheable and the 1-bit M field in the PTE is set, then there is a cache entry for the memory access and the 2-bit M field in the cache entry is set according to the page size.

TABLE 1

| Value of 2-bit M in cache entry | Type of page |
|---|---|
| 0 | Non-mirrored Page |
| 1 | Mirrored 4 K Page |
| 2 | Mirrored 2 M Page |
| 3 | Mirrored 1 G Page |

### Examples of Multiple M Bits in PTE and Multiple M Bits in Cache Entry

Some devices may need or benefit from contiguous physical mirrored memory out of the page level granularity. In this embodiment, multiple M bits are used in the page table for encoding more contiguous physical mirrored memory sizes (e.g., a 4-bit M as set forth in Table 2).

TABLE 2

| Value of 4-bit M | Type of page/region |
|---|---|
| 0 | Non-mirrored Page |
| 1 | Mirrored 4 K Page |
| 2 | Mirrored 2 M Page |
| 3 | Mirrored 1 G Page |
| 4 | Mirrored 4 M Region |
| 5 | Mirrored 8 M Region |
| 6 | Mirrored 16 M Region |
| 7 | Mirrored 32 M Region |
| 8 | Mirrored 64 M Region |
| 9 | Mirrored 128 M Region |
| 10 | Mirrored 256 M Region |
| 11 | Mirrored 512 M Region |
| 12 | Mirrored 2 G Region |
| 13 | Mirrored 8 G Region |
| 14 | Mirrored 32 G Region |
| 15 | Mirrored 64 G Region |

The foregoing Tables 1 and 2 are non-limiting examples. Other embodiments may use other than 1 bit or 4 bits and do not necessarily support all powers of two for given size.

In some embodiments, a primary/secondary region consists of two or more than two contiguous primary/secondary pages. All the PTEs for the pages in a primary region use the same M indication (e.g., the OS has the responsibility to set same M bit value across all pages mapping a larger page range). A primary region is mirrored by a secondary region.

In some embodiments, a best-matched M value is chosen for a contiguous physical mirrored memory. Wasted space may be addressed in the OS/software by having a mirrored memory allocator. For example, if a driver requests 100 MB contiguous physical mirrored memory, an embodiment of an allocator may setup a 128 MB mirrored area, give 100 MB to the driver, and keep the other 28 MB for possible future requests by other users for mirrored memory.

### Mirrored Memory Write from CPU Core to Memory Controller

Examples of a Mirrored Memory Write from CPU Core to Cache

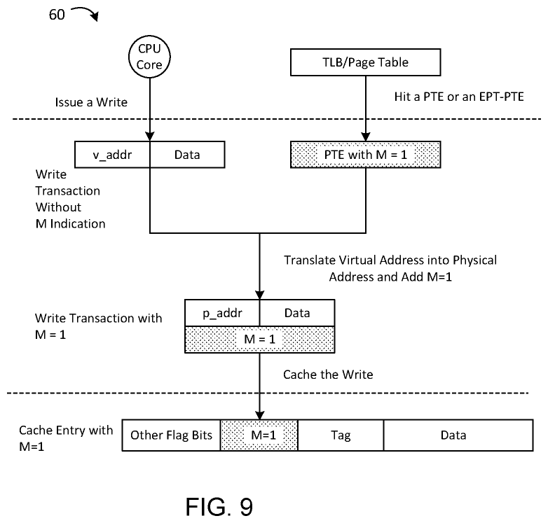

FIG. 9. shows an embodiment of a flow 60 for a mirrored memory write from a CPU core to a cache. Before the mirrored write, the OS has already set up a PTE with the M indication set for the memory write address. In this example, the M is set to 1 to indicate that the PTE is for a 4 KB mirrored page. The CPU core issues a memory write, then the MMU uses the PTE from a TLB or a page table to translate the virtual address of the write transaction into physical address and the MMU copies the M indication from the PTE to the write transaction. After the physical address has been determined and the M indication has been set, the write transaction is sent to the cache. The M indication is carried forward to the cache hierarchy, (e.g., the cache entries of a L1 cache, a L2 cache, and a last level cache (LLC) all contain the M indication if the cached data is mirrored in memory).

Examples of a Mirrored Memory Write from Cache to Memory Controller

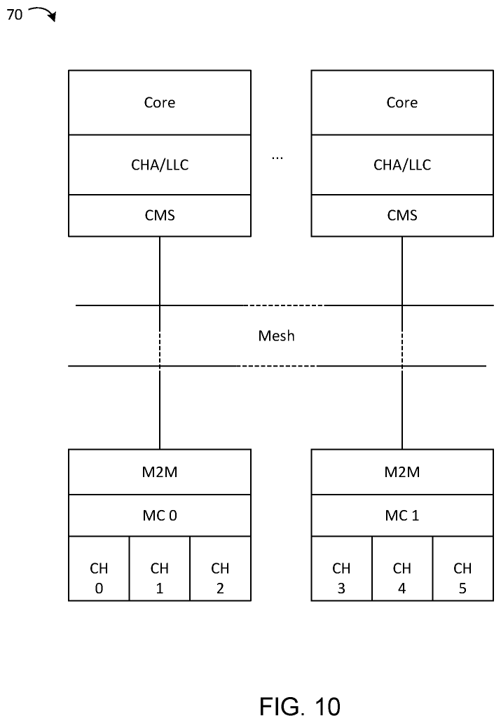

FIG. 10 shows a simplified block diagram of an architecture for a mesh on-chip interconnect system 70 that may be configured to utilize one or more aspects or features of the embodiments described herein. The mesh refers to the fabric that is a 2-dimensional array of half rings forming a system-wide interconnect grid. A common mesh stop (CMS) corresponds to a mesh stop station that facilitates an interface between a tile (e.g., a CPU core and a memory controller (MC)) and the fabric. The caching/home agent (CHA) interfaces with the CMS and maintains the cache coherency. One of the functions of the CHA is to map addresses (e.g., an evicted cache line from the LLC) being accessed to the target mesh stop of the MC. The CHA provides the necessary information required for routing to take place. A mesh to memory (M2M) block manages an interface between the mesh and the MC.

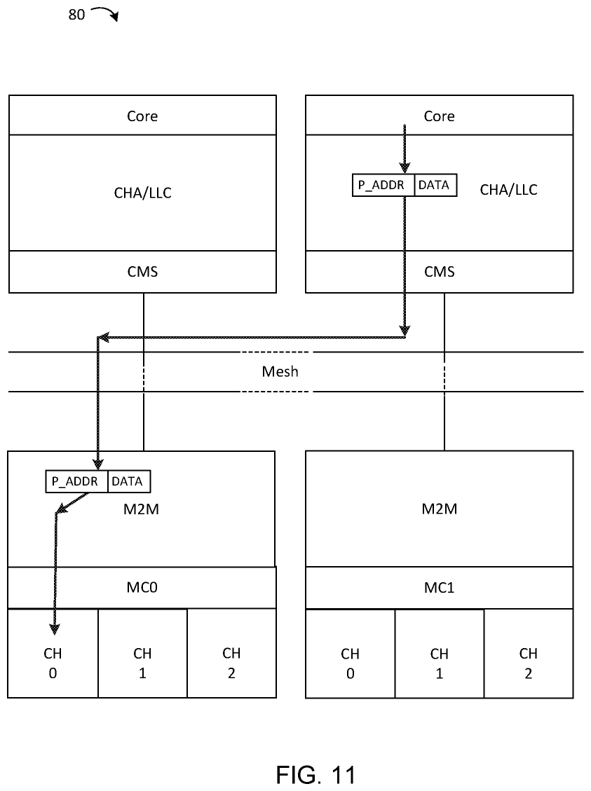

FIG. 11 shows an embodiment of a flow 80 for evicting non-mirrored data (e.g., M=0) from the LLC to memory with 6-channel interleaving. The CHA determines the target memory controller and the target memory channel to store the evicted non-mirrored data from the LLC. Then the non-mirrored data is routed to the target M2M via the mesh fabric. Finally, the non-mirrored data is sent to the MC by the M2M and the non-mirrored data stored only in the memory channel 0 of MC 0.

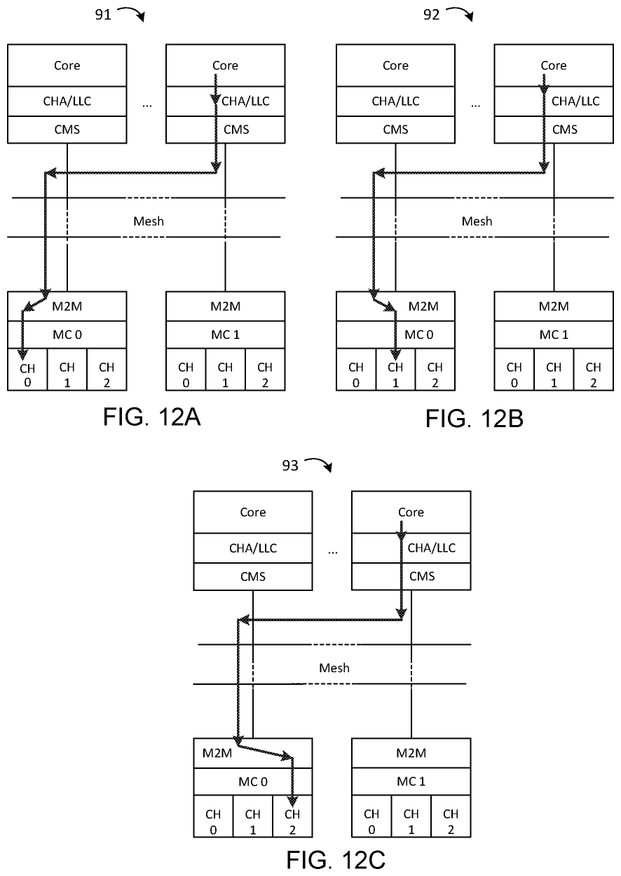

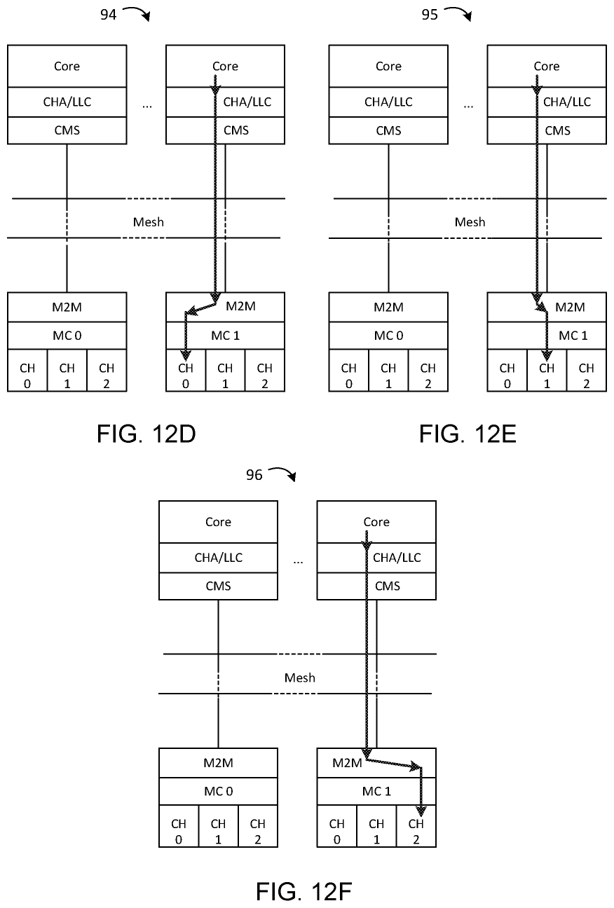

FIG. 12A to FIG. 12F show embodiments of flows 91 to 96 for respective sequences of non-mirrored data writes (e.g., M=0) from the LLC to memory with a 6-channel interleave across two memory controllers (MC 0 and MC 1). In these embodiments, the channel interleaving sequence is: MC0_CH0=>MC0_CH1=>MC0_CH2=>MC1_CH0=>MC1_CH1=>MC1_CH2=>MC0_CH0=>. . . .

In accordance with some embodiments, when the M field in a PTE/TLB/IOTLB/etc. indicates that the corresponding data is normal/non-mirrored (e.g., M is not set; M=0), the flow for handling the memory transaction may be similar to conventional flows for handling non-mirrored data. FIG. 12A shows the flow 91 for a write of non-mirrored data (M not set) to memory channel 0 of MC 0. FIG. 12B shows the flow 92 for a write of non-mirrored data (M not set) to memory channel 1 of MC 0. FIG. 12C shows the flow 93 for a write of non-mirrored data (M not set) to memory channel 2 of MC 0. FIG. 12D shows the flow 94 for a write of non-mirrored data (M not set) to memory channel 0 of MC 1. FIG. 12E shows the flow 95 for a write of non-mirrored data (M not set) to memory channel 1 of MC 1. FIG. 12F shows the flow 96 for a write of non-mirrored data (M not set) to memory channel 2 of MC 1.

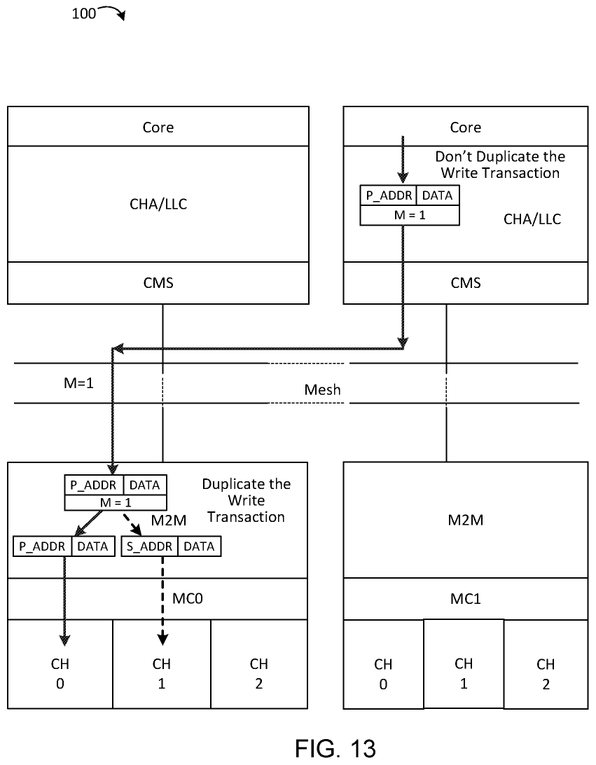

FIG. 13 shows an embodiment of a flow 100 for evicting mirrored data (e.g., M field is set) from the LLC to memory, where the primary data and secondary data are on different channels but on the same memory controller. First, the CHA detects a non-zero M indication in the write transaction and uses a mirroring address mapping function F(x) to map the primary address P_ADDR to a secondary address S_ADDR=F(P_ADDR). As described in further detail herein, the mapping function F(x) ensures that P_ADDR and S_ADDR are on different memory channels. Next, for this embodiment, the CHA determines that the primary address P_ADDR is in channel 0 of MC 0 and the secondary address S_ADDR is in channel 1 of MC 0. Accordingly, P_ADDR and S_ADDR are targeted on different channels but on the same memory controller.

In this embodiment, to save mesh traffic bandwidth, the CHA doesn't duplicate the write transaction but instead sends the write transaction with the M indication set to the mesh fabric. Next, the write transaction with the M indication set is routed to the target M2M via the mesh fabric. The M2M detects the M indication in the write transaction is a non-zero value, and then the M2M duplicates the primary write transaction to a secondary write transaction and sets the address of the secondary write transaction to S_ADDR=F(P_ADDR). The primary write transaction is then sent to the channel 0 of MC 0 by the M2M and the secondary write transaction (e.g., the mirrored copy) is sent to the channel 1 of MCM 0 by the M2M.

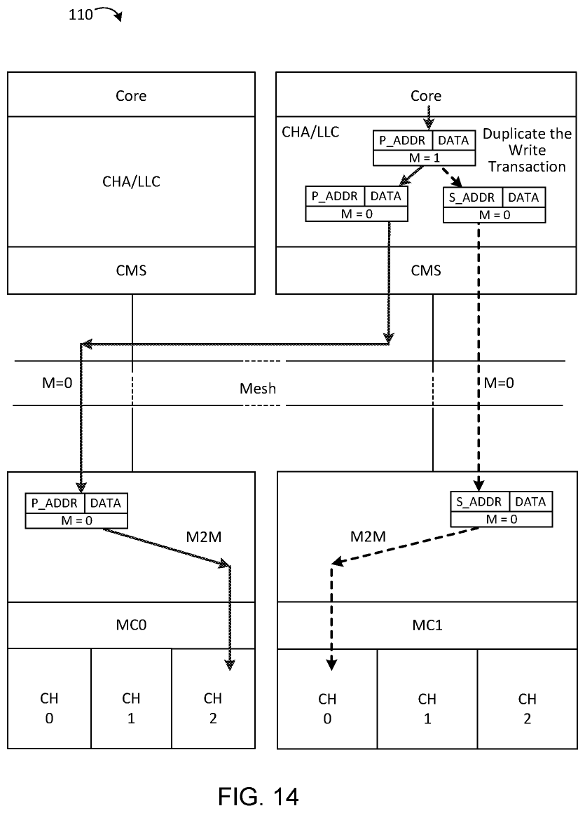

FIG. 14 shows an embodiment of a flow 110 for evicting mirrored data from the LLC to memory, where primary data and secondary data are spread across two memory controllers. The CHA detects a non-zero M indication in the write transaction and uses the mirroring address mapping function F(x) to map the primary address P_ADDR to the secondary address S_ADDR=F(P_ADDR). As previously noted, the mapping function F(x) makes sure that P_ADDR and S_ADDR are on different memory channels. In this embodiment, the CHA determines that the primary address P_ADDR is in channel 2 of MC 0 and the secondary address S_ADDR is in channel 0 of MC 1. Accordingly, P_ADDR and S_ADDR are targeted on different channels which are across two memory controllers.

Next, the CHA duplicates the primary write transaction to a secondary write transaction, and sets the address of the secondary write transaction to S_ADDR. The CHA then clears the M indications in the primary and the secondary write transactions, and sends the primary and the secondary write transactions to mesh fabric. The primary write transaction is routed to the M2M connected to MC 0 and the secondary write transaction is routed to the M2M connected to MC 1. The M2M connected to MC 0 detects the M indication of the write transaction is zero so that the M2M doesn't duplicate the primary write transaction and directly sends the write transaction to the memory channel 2 of MC 0. Similarly, the M2M connected to MC 1 detects the M indication of the write transaction is zero so that the M2M doesn't duplicate the secondary write transaction and directly sends the write transaction to the memory channel 0 of MC 1.

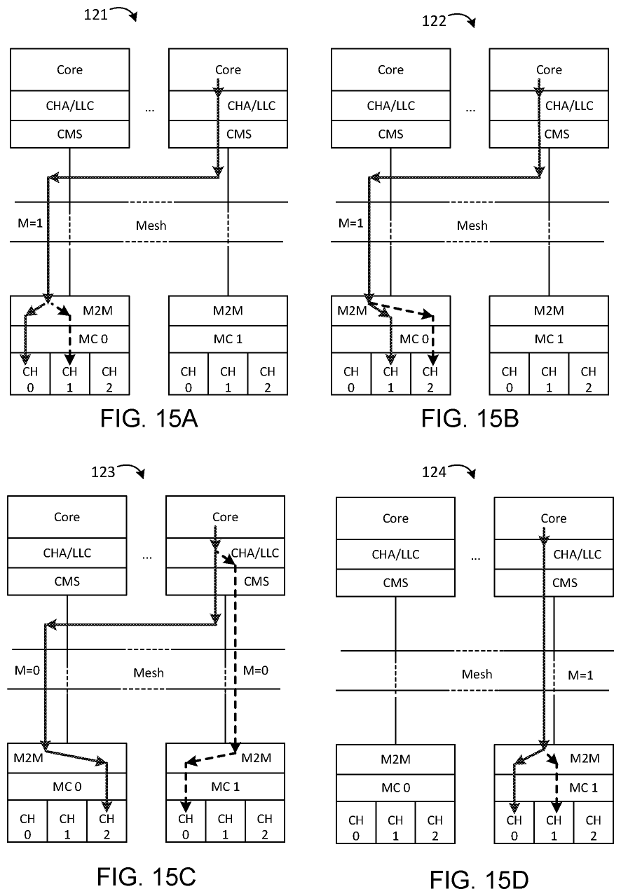

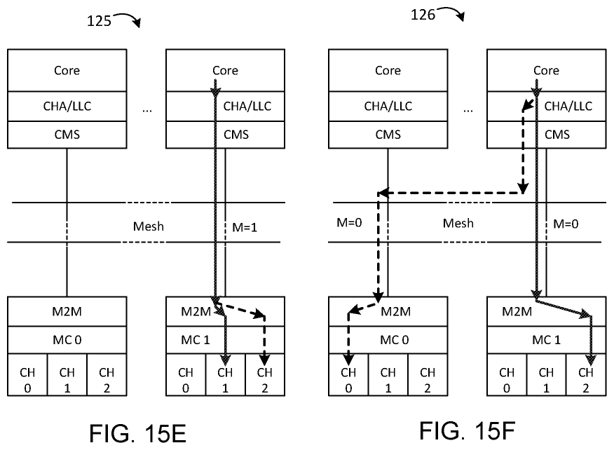

FIG. 15A to FIG. 15F show embodiments of flows 121 to 126 for respective mirrored write transactions with 6-channel interleaving. The memory channel interleaving sequence for these embodiments is as follows: 1) {Primary data goes to MC0_CH0, Secondary data goes to MC0_CH1}=> 2) {Primary data goes to MC0_CH1, Secondary data goes to MC0_CH2}=> 3) {Primary data goes to MC0_CH2, Secondary data goes to MC1_CH0}=> 4) {Primary data goes to MC1_CH0, Secondary data goes to MC1_CH1}=> 5) {Primary data goes to MC1_CH1, Secondary data goes to MC1_CH2}=> 6) {Primary data goes to MC1_CH2, Secondary data goes to MC0_CH0}=> 7) Repeat preceding #1).

FIG. 15A shows the flow 121 for a write of primary/secondary data to channel 0/1 of MC 0. FIG. 15B shows the flow 122 for a write of primary/secondary data to channel 1/2 of MC 0. FIG. 15C shows the flow 123 for a write of primary/secondary data to channel 2 of MC 0 and channel 0 of MC 1. FIG. 15D shows the flow 124 for a write of primary/secondary data to channel 0/1 of MC 1. FIG. 15E shows the flow 125 for a write of primary/secondary data to channel 1/2 of MC 1. FIG. 15F shows the flow 126 for a write of primary/secondary data to channel 2 of MC 1 and channel 0 of MC 0.

Examples of How to Ensure that Primary/Secondary Data are on Different Channels

An embodiment of a mirroring address mapping bijection function F(x) maps the primary address P_ADDR of the primary write transaction to the secondary address S_ADDR=F(P_ADDR) of the secondary write transaction. If the granularity of memory channel interleaving is less than or equal to the page size, embodiments of a suitable mapping function F(x) ensures that P_ADDR and S_ADDR=F(P_ADDR) are on different memory channels. Table 3 shows example channel interleaving granularities of some servers that are less than or equal to the common page size of 4096 bytes (4 KB).

TABLE 3

| | Granularity of |
|---|---|
| | Channel Interleaving |
| Example Server | in Bytes |
| Server 1 (e.g., Sandy-Bridge) | 64 |
| Server 2 (e.g., Haswell/Broadwell) | 64 or 128 |
| Server 3 (e.g., Skylake) | 64, 256, 4 K, or 1 G |

In this embodiment, the M indication is moved with the evicted data from the cache to the CHA and then to the M2M. If M is set, the CHA determines the S_ADDR=F(P_ADDR) and checks whether P_ADDR and S_ADDR are across two memory controllers as follows: 1) if P_ADDR and S_ADDR are across two memory controllers, then the CHA duplicates the primary write transaction to a secondary write transaction attached with the S_ADDR, clears M indications in the primary and secondary write transactions, and sends the primary and secondary write transactions to the mesh fabric; and 2) if P_ADDR and S_ADDR are in the same memory controller, then the CHA will directly send the primary write transaction to the mesh fabric with the M indication set, and the target M2M duplicates the primary write transaction to the secondary write transaction attached with the S_ADDR.

In the following examples, the memory channel interleaving is N-way, the granularity of memory channel interleaving is G which is a power of two, the page size is P which is a power of two, and G divides P (e.g., N is a number of channels, G is the channel interleave granularity in bytes, P is the page size in bytes, and P is an integer multiple of G)

### Examples Where N Divides P÷G (e.g., P is an Integer Multiple of (N Times G))

If N divides P÷G (e.g., generally the case with an even number of channels), then a mapping function F(x) that implement the following Equation 1 ensures that the primary address P_ADDR and the secondary address S_ADDR=F(P_ADDR) are on different channels:

$$S\_ADDR = \qquad [ Eq . 1 ]$$

$$\{ \begin{matrix}P\_ADDR + P + G , & when ( \frac{P\_ADDR}{G} ) \% N \neq N - 1 \\ P\_ADDR + P - ( N - 1 ) \times G , & when ( \frac{P\_ADDR}{G} ) \% N = N - 1\end{matrix}$$

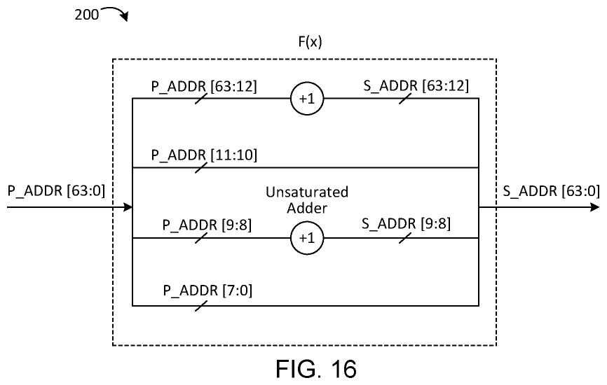

With reference to FIG. 16, an embodiment of a logic circuit 200 implements a suitable mapping function F(x) for Eq. 1 in an example where N=4, G=256, and P=4096. The adder to increase P_ADDR[9:8] by one is unsaturated addition. For example, the adder is configured such that if P_ADDR[9:8]=3 (the maximum value) then the result after adding one to P_ADDR is rounded towards to zero.

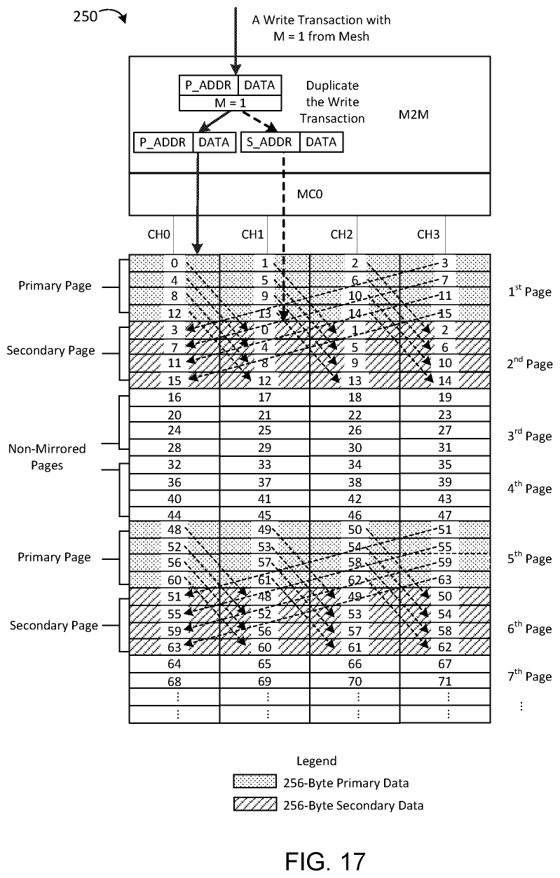

FIG. 17 shows an embodiment of a flow 250 for an example system where N=4, G=256, and P=4096. In this example, the 1st page is mirrored by the 2nd page, the 5th page is mirrored by the 6th page, and the other pages are non-mirrored. The flow 250 shows how the primary write transactions and the secondary write transactions duplicated by the M2M are stored to memory channels when N=4, G=256, and P=4096. The secondary addresses S_ADDR of the secondary write transactions are determined by the F(x) from the logic circuit 200 in FIG. 16 such that: 1) if the primary write transaction is sent to channel 0, then the duplicated secondary write transaction (in the next page) is sent to channel 1; 2) if the primary write transaction is sent to channel 1, then the duplicated secondary write transaction (in the next page) is sent to channel 2; 3) if the primary write transaction is sent to channel 2, then the duplicated secondary write transaction (in the next page) is sent to channel 3; and 4) if the primary write transaction is sent to channel 3, then the duplicated secondary write transaction (in the next page) is sent to channel 0.

### Examples Where N Can't Divide P÷G (e.g., P is Not an Integer Multiple of (N Times G))

If N can't divide P÷G, then a mapping function F(x) that implement the following Equation 2 ensures that the primary address P_ADDR and the secondary address S_ADDR=F(P_ADDR) are on different channels:

S_ADDR=P_ADDR+P [Eq. 2]

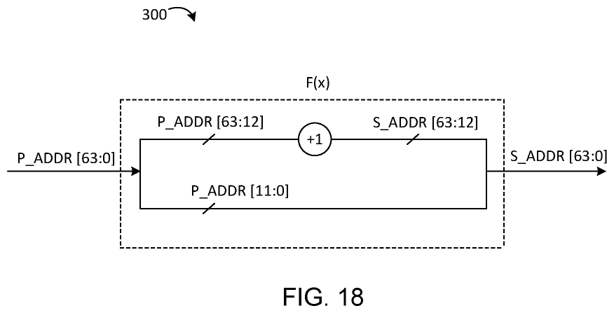

With reference to FIG. 18, an embodiment of a logic circuit 300 implements a suitable mapping function F(x) for an example where N=3, G=256, and P=4096.

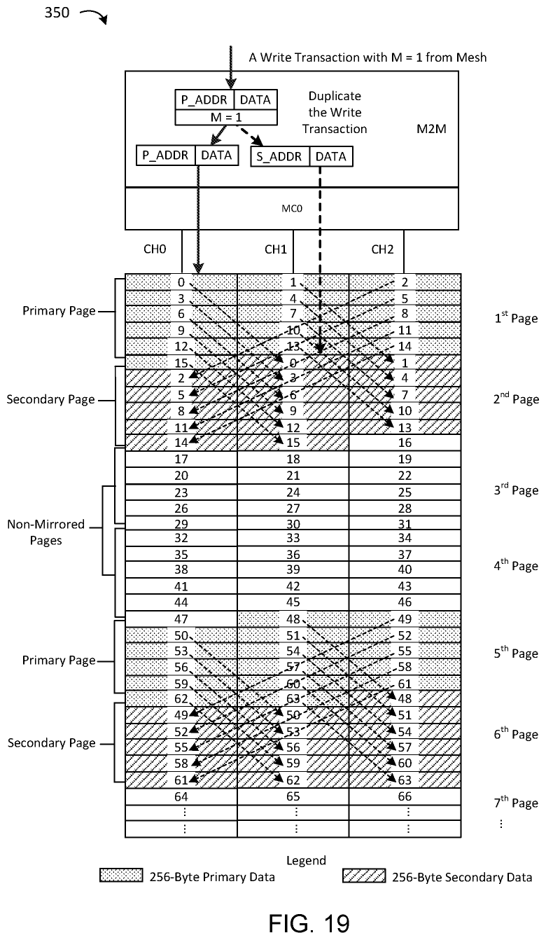

FIG. 19 shows an embodiment of a flow 350 for an example system where N=3, G=256, and P=4096. In this example, the 1st page is mirrored by the 2nd page, the 5th page is mirrored by the 6th page, and the other pages are non-mirrored. The flow 350 shows how the primary write transactions and the secondary write transactions duplicated by the M2M are stored to memory channels when N=3, G=256, and P=4096. The secondary addresses S_ADDR of the secondary write transactions are determined by the F(x) from the logic circuit 300 in FIG. 18 such that: 1) if the primary write transaction is sent to channel 0, then the duplicated secondary write transaction (in the next page) is sent to channel 1; 2) if the primary write transaction is sent to channel 1, then the duplicated secondary write transaction (in the next page) is sent to channel 2; and 3) if the primary write transaction is sent to channel 2, then the duplicated secondary write transaction (in the next page) is sent to channel 0.

### Mirrored Memory Read from Memory Controller to CPU Core

In some embodiments, a mirrored memory read may be similar to the mirrored memory write. The M mirroring indication is also set in the PTE by the OS and the M indication is moved along with the read transaction to caches, the CHA, the mesh fabric, the M2M, and the memory controller. A primary read transaction is made at address P_ADDR and an optional secondary read transaction may be made at address S_ADDR=F(P_ADDR). Advantageously, the number of channel interleaving ways for the primary and secondary read transactions is the same as the number of channel interleaving ways for non-mirrored read transactions. Some embodiments make the distribution of the primary or secondary read transactions be more even across channels and may also improve the memory bandwidth.

Examples where Both Primary Read and Secondary Read Transactions are Performed

In this embodiment, both the primary read transaction at address P_ADDR and the corresponding secondary read transaction at address S_ADDR=F(P_ADDR) are performed. The CHA (e.g., if P_ADDR and S_ADDR are across two memory controllers) or the M2M (e.g., if P_ADDR and S_ADDR are at the same memory controller) checks whether the primary read data and secondary read data are both good, and if one is bad then the CHA or M2M writes back memory with the good data and forwards the good data to the requester.

Examples where Only a Primary Read Transaction is Performed

In this embodiment, only the primary read transaction at address P_ADDR is performed. The corresponding secondary read transaction at address S_ADDR=F(P_ADDR) isn't performed unless there is an uncorrectable error on the primary read transaction. If there is an uncorrectable error on the primary read transaction, the CHA (e.g., if P_ADDR and S_ADDR are across two memory controllers) or the M2M (e.g., if P_ADDR and S_ADDR are at the same memory controller) performs the secondary read transaction at address S_ADDR=F(P_ADDR) and copies the good data back to the primary page to fix the error. For this embodiment, the memory bandwidth is advantageously increased by 100% compared to the conventional mirroring methods.

### Mirrored Memory Management Examples

Before mirroring data, the OS sees all the physical memory available for use (e.g., except memory reserved by BIOS/firmware for special uses). The OS itself may be also already mirrored by BIOS/firmware. The mirrored memory is dynamically setup/allocated/freed at a page granularity on demand at run time. When the OS allocates a mirrored page/region: 1) any pending cache lines in caches for the secondary page/region address range are flushed; 2) both the primary and secondary page/region are removed from the free memory pool; and 3) the corresponding M indication bit(s) are setup in the PTE(s) for the primary page/region. Note that before allocating the mirrored page/region, the secondary page/region may be used as a non-mirrored page/region so that there may be some pending cache lines in the caches. Once a non-mirrored page/region becomes a secondary page/region for redundancy, cache lines are not allocated in caches for the secondary page/region. Also, there are no PTEs for the secondary page/region.

When the OS frees a mirrored page/region: 1) any pending cache lines are flushed and old M bits in caches for the primary page/region are cleared; and 2) both the primary and secondary page/region are added to the free memory pool. The performance impact of a cache flush may depend on the size of the mirrored page that is being created or freed, and on the frequency of mirror page creation/deletion (e.g., in general the frequency may be low). The OS/virtual machine manager (VMM) has some control over the rate by applying some hysteresis to mirror creation/deletion (e.g., instead of releasing mirror pages immediately when freed, keep recently released mirror pages in a pool for re-use, and only grow/shrink the pool when demand is proven after some time).

### Examples of OS APIs for Mirrored Memory Allocation/De-Allocation

For those existed memory allocation APIs which have a size parameter and a flag parameter (e.g., kmalloc(size, flag), mmap( . . . , size, flag, . . . ), etc.), the flag may be a bitmap that indicates a memory attribute. In some cases, a new bitmap value “MIRRORED” may be added to the bitmap flag. For allocating some mirrored memory, suitable APIs may make the flag contain the bitmap value of “MIRRORED,” examples of which are shown in Table 4.

TABLE 4

| Non-mirroring | |
|---|---|
| memory allocation | Mirroring memory allocation |
| mmap (. . . , size, flag, . . .) | mmap |
| | (. . . , size, flag \| MIRRORED, . . .) |
| kmalloc (size, flag) | kmalloc (size, flag \| MIRRORED) |
| . . . | . . . |

For a memory allocation APIs which don't have a suitable flag parameter for a memory attribute (e.g., malloc(size), kmalloc(size), etc.), a comparable API may be provided for allocating minoring memory, as shown in Table 5.

TABLE 5

| Non-mirroring | |
|---|---|
| memory allocation | Mirroring memory allocation |
| malloc (size) | mmalloc (size) |
| vmalloc (size) | mvmalloc (size) |
| . . . | . . . |

Table 6 lists examples of features of different conventional memory mirroring technology in comparison with embodiments of demand-based memory mirroring at a page granularity.

TABLE 6

| | | | Non- | |
|---|---|---|---|---|
| | Mirrored | Mirrored | Mirrored | Mirrored |
| | Memory | Memory | Interleaving | Interleaving |
| Mirroring Type | Granularity | Allocation | Ways | Ways |
| Full Channel | 50% of Total | Static | None | N/2 |
| Mirroring | Memory | | | |
| Address Range | Static Range | Static | N | N/2 |
| Mirroring | | | | |
| Demand-Based | Page Size | On | N | N |
| Mirroring | | Demand | | |

Embodiments of demand-based mirroring at a page granularity also provides N interleaving ways when only reading the secondary page, as compared to N/2 for both full channel mirroring and address range mirroring, advantageously supporting 100% memory bandwidth when only reading the secondary page.

### An Example of Usage Flow

In this example, the size of total installed physical memory is Mtotal, the size of reserved memory by BIOS/firmware is Mreserved, the size of the region for OS is Mos, and the region for OS is mirrored. In an example usage flow: 1) the BIOS/firmware allocates a mirrored memory region where the OS image is loaded to run; 2) the BIOS/firmware boots the OS and reports the available memory to the OS with a size of “Mtotal−Mreserved−2*Mos” to the OS available for use; 3) the OS allocates mirrored/non-mirrored memory regions to start up critical/non-critical tasks respectively on demand; and 4) the OS and/or other tasks dynamically setup/allocate/free mirrored memory regions on demand at a page granularity for their critical data and critical run-time code. In some embodiments, a bootloader and the OS boot have paging enabled. When allocating mirrored memory, the OS sets up the M indication bit(s) in the corresponding PTE entries for the mirrored memory and decreases the size of total free memory by the double-size of the mirrored memory. If uncorrectable errors occur in the mirrored memory (e.g., if a read from the primary page/region detects an uncorrectable error), the hardware uses the backup copy in the secondary page/region to both supply the correct value to the CPU, and to try to fix the error in the primary page/region. The recovery process is transparent for the OS/tasks.

### Examples of an Extension for Virtualization Environment

For an example virtualization environment (e.g., qemu-KVM (kernel-based virtual machine)) to support an embodiment of demand-based mirroring at a page granularity, an extended page table PTE (EPT-PTE) entry may be further extended to contain the mirror indication M.

### Examples of Mirroring at Guest OS Granularity

In this embodiment, the mirroring granularity is at guest OS (e.g., either a memory-non-mirrored guest OS or a memory-mirrored guest OS) and the mirroring control is provided just at the VMM (e.g., KVM/host OS kernel) level. This example use case offers a user a choice of mirrored or non-mirrored memory for their guest OS.

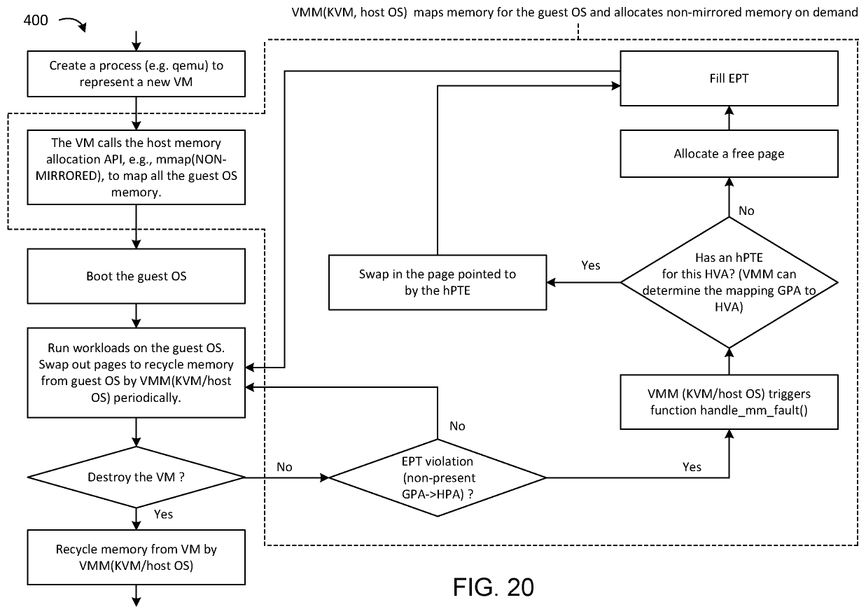

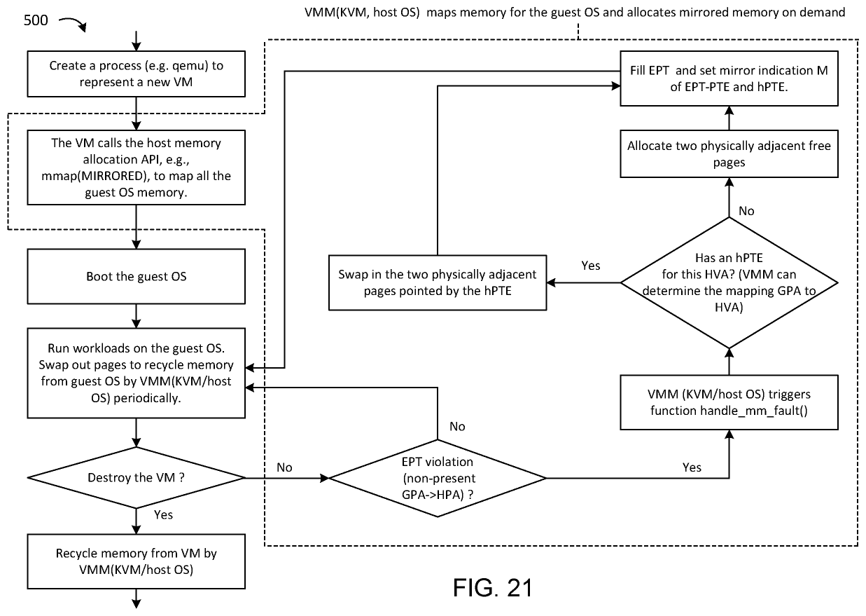

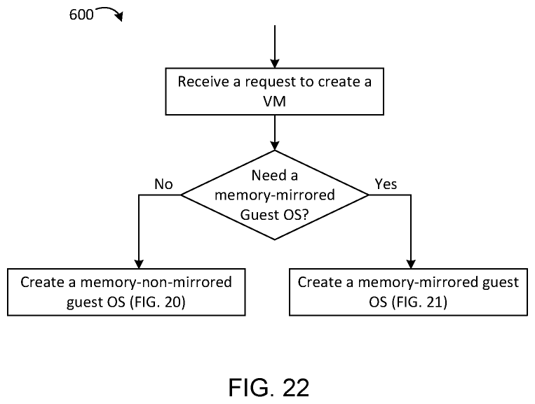

FIG. 20 shows an embodiment of a method 400 for a lifecycle of a non-mirrored guest OS, where the choice indicated by the user is for M to be not set (e.g., M=0). The method 400 may be similar to a conventional memory-non-mirrored guest OS (e.g., including how the physical memory is allocated to the guest OS). At first the VM (a process of a host OS) uses the function mmap(NON-MIRRORED) to map all the guest OS memory but does not yet allocate physical memory (e.g., allocation on demand). When the guest OS allocates a page and the EPT violation (non-present GPA->HPA) occurs, the VMM triggers the host OS kernel function handle_mm_fault( ) to swap in the page or allocate a new free physical page and fill the EPT. The VMM may recycle memory from the guest OS by swapping out pages periodically.

FIG. 21 shows an embodiment of a method 500 for a lifecycle of a memory-mirrored guest OS, where the choice indicated by the user is for M to be set, and how the mirrored memory is allocated to the guest OS. The mirrored memory used by the guest OS is managed by the host OS. The main difference between FIG. 20 and FIG. 21 is that the VM uses the function mmap(MIRRORED) with the mirror flag instead of mmap(NON-MIRRORED) to map all the guest OS memory in mirroring. The VMM (KVM, host OS) allocates the mirrored memory (two physically adjacent pages, but only assigns the page with the lower address) to the guest OS and removes the page with the higher address from the free memory pool.

FIG. 22 shows an embodiment of a flow 600 for creating a memory-non-mirrored guest OS or a memory-mirrored guest OS for a user. To accommodate a demand-based mirroring feature to this embodiment, a selection is added in the VMM that uses mmap(NON-MIRRORED) or mmap(MIRRORED) to map guest OS memory.

### Examples of Mirroring at Page Granularity for a Guest OS

In this embodiment, the guest OS allocates non-mirrored memory or mirrored memory at page granularity on demand similar to a bare-metal environment. The request of allocating mirrored memory is initiated by the guest OS and managed by both the guest OS and the VMM (KVM/host OS kernel).

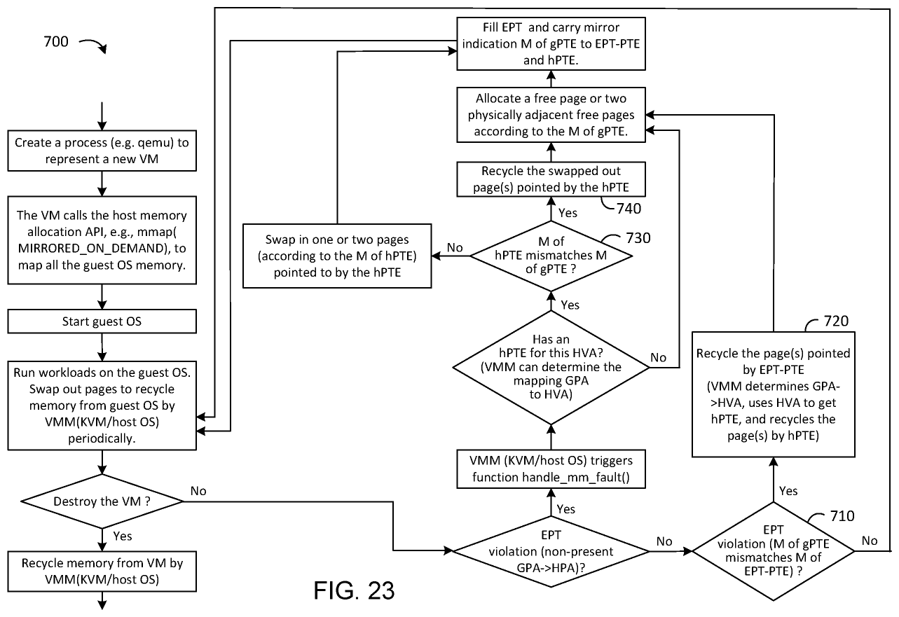

FIG. 23 shows an embodiment of a method 700 for a lifecycle of a guest OS and how the non-mirrored page or the mirrored page are allocated or recycled by the VMM (KVM/host OS kernel) at a page granularity on the demand of guest OS. When a guest OS allocates a non-mirrored or mirrored page, the value of a mirror indication M of a guest PTE (gPTE) is carried forward to the mirror indication M of the EPT-PTE and a host PTE (hPTE). The VMM manages the physical pages used by the guest OS and makes sure the allocated two physical pages for mirrored memory are physically adjacent.

In some kernel-based virtual machines (VMs), the VMM doesn't know if the guest OS recycles a page in the guest OS environment, which may result in a mismatch among the mirror indications M of the gPTE, the EPT-PTE, and the hPTE. For example: 1) The guest OS allocates a mirrored page, and the M of the gPTE, the EPT-PTE and the hPTE are all set; 2) the guest OS recycles the mirrored page and clears the related gPTE, but the VMM isn't notified on the change, so the M values of the EPT-PTE and the hPTE are kept at the old value; and 3) the guest OS re-allocates the same page (e.g., the same GPA address as the previously mirrored page) as non-mirrored memory. The M of the gPTE is unset, but the M values of the EPT-PTE and the hPTE are still set, thereby causing an M mismatch.

In some embodiments, the M mismatch may be overcome by adding a new EPT-violation on an M indication of the gPTE mismatching the M indication of the corresponding EPT-PTE as showed at decision block 710 in FIG. 23. This kind of EPT-violation indicates that the guest OS has recycled the page(s) pointed to by the EPT-PTE, but the VMM doesn't know it. The VMM then recycles the page(s) pointed to by the EPT-PTE as shown at block 720 in FIG. 23. The VMM determines the mapping for GPA to HVA, uses the HVA to get the hPTE, and recycles the old page(s) pointed to by the hPTE. After recycling the old page(s), the VMM allocates a free physical page or two physically adjacent free pages according the value of the M indication of the gPTE, fills the EPT-PTE and carries the M indication of gPTE to both the EPT-PTE and the hPTE. For those physical pages swapped out by the host OS, the potential M mismatch is resolved on the normal EPT violation (non-preset GPA->HPA) path, as shown at block 730 and block 740 in FIG. 23.

Without being limited to theory of operation, the page(s) are recycled and new free page(s) are allocated on a M mismatch because: 1) if the old request of the guest OS is a mirrored page (actually two physically adjacent pages) and the new request of guest OS is an non-mirrored page (single page) at the same GPA, returning the two physically adjacent pages to the host OS first and then asking for a single page makes the host OS have more physically adjacent pages for future page mirroring; and 2) if the old request of the guest OS is an non-mirrored page and the new request is a mirrored page, then two physically adjacent free pages are needed. But the physically adjacent page of the old non-mirrored page may be not a free page. Accordingly, the old physical page is returned and two physically adjacent free pages are requested.

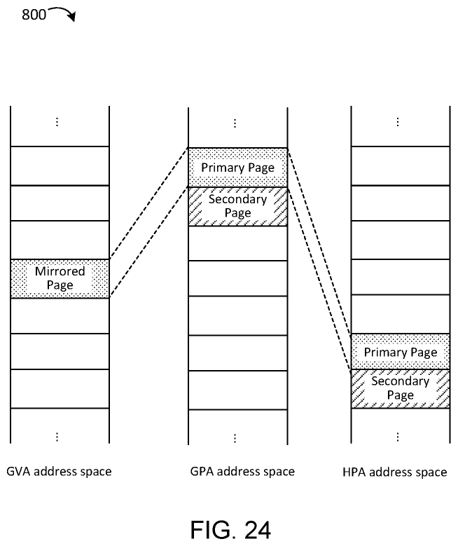

Embodiments may guarantee that the allocated two physical pages for mirrored memory needed by the guest OS are physically adjacent and the mirror indications M of the gPTE, the EPT-PTE, and the hPTE are consistent. FIG. 24 shows a memory space 800 where, either in a GPA address space view or in a HPA address space view, the two pages allocated for the mirrored page are all continuous. Accordingly, a cache flush instruction clflush(GVA) used by the guest OS can be also used for the mirroring page management (e.g., similar to the bare-metal environment). The memory space 800 shows how a guest OS may use mirrored memory similar to the bare-metal environment.

Those skilled in the art will appreciate that a wide variety of devices may benefit from the foregoing embodiments. The following exemplary core architectures, processors, and computer architectures are non-limiting examples of devices that may beneficially incorporate embodiments of the technology described herein.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

FIG. 25A is a block diagram illustrating both an exemplary in-order pipeline and an exemplary register renaming, out-of-order issue/execution pipeline according to embodiments of the invention. FIG. 25B is a block diagram illustrating both an exemplary embodiment of an in-order architecture core and an exemplary register renaming, out-of-order issue/execution architecture core to be included in a processor according to embodiments of the invention. The solid lined boxes in FIGS. 25A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 25A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 25B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

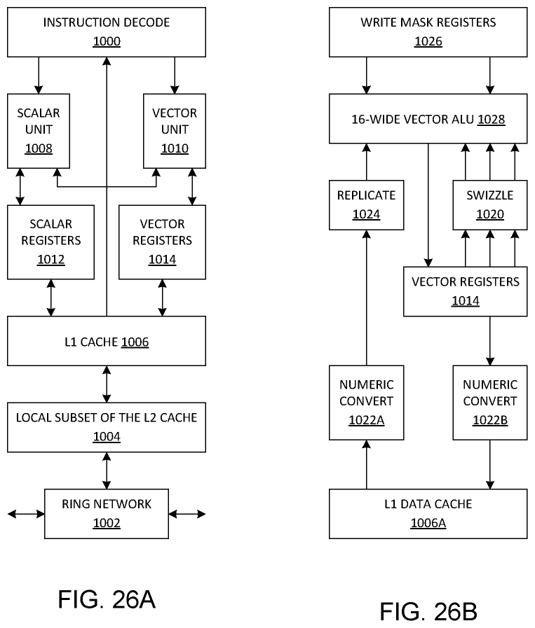

FIGS. 26A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 26A is a block diagram of a single processor core, along with its connection to the on-die interconnect network 1002 and with its local subset of the Level 2 (L2) cache 1004, according to embodiments of the invention. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 1012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The local subset of the L2 cache 1004 is part of a global L2 cache that is divided into separate local subsets, one per processor core. Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 26B is an expanded view of part of the processor core in FIG. 26A according to embodiments of the invention. FIG. 26B includes an L1 data cache 1006A part of the L1 cache 1006, as well as more detail regarding the vector unit 1010 and the vector registers 1014. Specifically, the vector unit 1010 is a 16-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating resulting vector writes.

FIG. 27 is a block diagram of a processor 1100 that may have more than one core, may have an integrated memory controller, and may have integrated graphics according to embodiments of the invention. The solid lined boxes in FIG. 27 illustrate a processor 1100 with a single core 1102A, a system agent 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of respective caches 1104A-N within the cores 1102A-N, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

### Exemplary Computer Architectures

FIGS. 28-31 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 28, shown is a block diagram of a system 1200 in accordance with one embodiment of the present invention. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 28 with broken lines. Each processor 1210, 1215 may include one or more of the processing cores described herein and may be some version of the processor 1100.

The memory 1240 may be, for example, dynamic random access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

Referring now to FIG. 29, shown is a block diagram of a first more specific exemplary system 1300 in accordance with an embodiment of the present invention. As shown in FIG. 29, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 29, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339 and an interface 1392. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 29, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 29, a system may implement a multi-drop bus or other such architecture.

Referring now to FIG. 30, shown is a block diagram of a second more specific exemplary system 1400 in accordance with an embodiment of the present invention. Like elements in FIGS. 29 and 30 bear like reference numerals, and certain aspects of FIG. 29 have been omitted from FIG. 30 in order to avoid obscuring other aspects of FIG. 30.

FIG. 30 illustrates that the processors 1370, 1380 may include integrated memory and I/O control logic (“CL”) 1472 and 1482, respectively. Thus, the CL 1472, 1482 include integrated memory controller units and include I/O control logic. FIG. 30 illustrates that not only are the memories 1332, 1334 coupled to the CL 1472, 1482, but also that I/O devices 1414 are also coupled to the control logic 1472, 1482. Legacy I/O devices 1415 are coupled to the chipset 1390.

Referring now to FIG. 31, shown is a block diagram of a SoC 1500 in accordance with an embodiment of the present invention. Similar elements in FIG. 27 bear like reference numerals. Also, dashed lined boxes are optional features on more advanced SoCs. In FIG. 31, an interconnect unit(s) 1502 is coupled to: an application processor 1510 which includes a set of one or more cores 1102A-N and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 29, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 32 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 32 shows a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that is operable to generate x86 binary code 1606 (e.g., object code) that can, with or without additional linkage processing, be executed on the processor with at least one x86 instruction set core 1616. Similarly, FIG. 32 shows the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, CA and/or that execute the ARM instruction set of ARM Holdings of Sunnyvale, CA). The instruction converter 1612 is used to convert the x86 binary code 1606 into code that may be natively executed by the processor without an x86 instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have an x86 instruction set processor or core to execute the x86 binary code 1606.

### ADDITIONAL NOTES AND EXAMPLES

Example 1 includes an integrated circuit, comprising first circuitry to manage a memory in accordance with a page size and a channel interleave granularity, and second circuitry coupled to the first circuitry, the second circuitry to store data in a primary region of the memory at a primary address, and manage a mirror of the data in a secondary region of the memory at a secondary address at a regional granularity on demand at run time.

Example 2 includes the integrated circuit of Example 1, wherein the second circuitry is further to one or more of setup, allocate, and free the secondary region of the memory for the mirror of the data on demand at run time.

Example 3 includes the integrated circuit of any of Examples 1 to 2, wherein the regional granularity corresponds to a page granularity.

Example 4 includes the integrated circuit of any of Examples 1 to 3, wherein the second circuitry is further to adjust a total amount of mirrored memory on demand at run time.

Example 5 includes the integrated circuit of any of Examples 1 to 4, wherein the second circuitry is further to utilize a same number of interleaved ways for mirrored memory as a number of interleaved ways utilized for non-mirrored memory.

Example 6 includes the integrated circuit of any of Examples 1 to 5, wherein the second circuitry is further to determine if the primary region is mirrored based on an indication stored in a page table entry.

Example 7 includes the integrated circuit of any of Examples 1 to 6, wherein the second circuitry is further to calculate the secondary address to store the mirror of the data at an adjacent neighbor region of the primary region as a function of the primary address.

Example 8 includes the integrated circuit of Example 7, wherein the function provides a calculated address to a different memory channel from a memory channel of the primary address.

Example 9 includes the integrated circuit of Example 8, wherein the function is based on the primary address and the regional granularity.

Example 10 includes the integrated circuit of Example 9, wherein the function is further based on a number of interleaved channels and the channel interleave granularity.

Example 11 includes a method, comprising controlling a memory by a memory controller in accordance with a page size and a channel interleave granularity, storing data in a primary region of the memory at a primary address, and managing a mirror of the data in a secondary region of the memory at a secondary address at a regional granularity on demand at run time.

Example 12 includes the method of Example 11, further comprising one or more of setting up, allocating, and freeing the secondary region of the memory for the mirror of the data on demand at run time.

Example 13 includes the method of any of Examples 11 to 12, wherein the regional granularity corresponds to a page granularity.

Example 14 includes the method of any of Examples 11 to 13, further comprising adjusting a total amount of mirrored memory on demand at run time.

Example 15 includes the method any of Examples 11 to 14, further comprising utilizing a same number of interleaved ways for mirrored memory as a number of interleaved ways utilized for non-mirrored memory.

Example 16 includes the method any of Examples 11 to 15, further comprising determining if the primary region is mirrored based on an indication stored in a page table entry.

Example 17 includes the method of any of Examples 11 to 16, further comprising calculating the secondary address to store the mirror of the data at an adjacent neighbor region of the primary region as a function of the primary address.

Example 18 includes the method of Example 17, wherein the function provides a calculated address to a different memory channel from a memory channel of the primary address.

Example 19 includes the method of Example 18, wherein the function is based on the primary address and the regional granularity.

Example 20 includes the method of Example 19, wherein the function is further based on a number of interleaved channels and the channel interleave granularity.

Example 21 includes an apparatus, comprising a memory, and a controller communicatively coupled to the memory, the controller including circuitry to manage the memory in accordance with a page size and a channel interleave granularity, store data in a primary region of the memory at a primary address, and manage a mirror of the data in a secondary region of the memory at a secondary address at a regional granularity on demand at run time.

Example 22 includes the apparatus of Example 21, wherein the circuitry is further to one or more of setup, allocate, and free the secondary region of the memory for the mirror of the data on demand at run time.

Example 23 includes the apparatus of any of Examples 21 to 22, wherein the regional granularity corresponds to a page granularity.

Example 24 includes the apparatus of any of Examples 21 to 23, wherein the circuitry is further to adjust a total amount of mirrored memory on demand at run time.

Example 25 includes the apparatus of any of Examples 21 to 24, wherein the circuitry is further to utilize a same number of interleaved ways for mirrored memory as a number of interleaved ways utilized for non-mirrored memory.

Example 26 includes the apparatus of any of Examples 21 to 25, wherein the circuitry is further to determine if the primary region is mirrored based on an indication stored in a page table entry.

Example 27 includes the apparatus of any of Examples 21 to 26, wherein the circuitry is further to calculate the secondary address to store the mirror of the data at an adjacent neighbor region of the primary region as a function of the primary address.

Example 28 includes the apparatus of Example 27, wherein the function provides a calculated address to a different memory channel from a memory channel of the primary address.

Example 29 includes the apparatus of Example 28, wherein the function is based on the primary address and the regional granularity.

Example 30 includes the apparatus of Example 29, wherein the function is further based on a number of interleaved channels and the channel interleave granularity.

Example 31 includes an apparatus, comprising means for controlling a memory by a memory controller in accordance with a page size and a channel interleave granularity, means for storing data in a primary region of the memory at a primary address, and means for managing a mirror of the data in a secondary region of the memory at a secondary address at a regional granularity on demand at run time.

Example 32 includes the apparatus of Example 31, further comprising means for one or more of setting up, allocating, and freeing the secondary region of the memory for the mirror of the data on demand at run time.

Example 33 includes the apparatus of any of Examples 31 to 32, wherein the regional granularity corresponds to a page granularity.

Example 34 includes the apparatus of any of Examples 31 to 31, further comprising means for adjusting a total amount of mirrored memory on demand at run time.

Example 35 includes the apparatus any of Examples 31 to 34, further comprising means for utilizing a same number of interleaved ways for mirrored memory as a number of interleaved ways utilized for non-mirrored memory.

Example 36 includes the apparatus any of Examples 31 to 35, further comprising means for determining if the primary region is mirrored based on an indication stored in a page table entry.

Example 37 includes the apparatus of any of Examples 31 to 36, further comprising means for calculating the secondary address to store the mirror of the data at an adjacent neighbor region of the primary region as a function of the primary address.

Example 38 includes the apparatus of Example 37, wherein the function provides a calculated address to a different memory channel from a memory channel of the primary address.

Example 39 includes the apparatus of Example 38, wherein the function is based on the primary address and the regional granularity.

Example 40 includes the apparatus of Example 39, wherein the function is further based on a number of interleaved channels and the channel interleave granularity.

Techniques and architectures for demand-based memory mirroring at a page granularity are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

1-25. (canceled)

26. An integrated circuit, comprising:
first circuitry to manage a memory in accordance with a page size and a channel interleave granularity; and
second circuitry coupled to the first circuitry, the second circuitry to:
store data in a primary region of the memory at a primary address, and
manage a mirror of the data in a secondary region of the memory at a secondary address at a regional granularity on demand at run time.

27. The integrated circuit of claim 26, wherein the second circuitry is further to:
one or more of setup, allocate, and free the secondary region of the memory for the mirror of the data on demand at run time.

28. The integrated circuit of claim 26, wherein the regional granularity corresponds to a page granularity.

29. The integrated circuit of claim 26, wherein the second circuitry is further to:
calculate the secondary address to store the mirror of the data at an adjacent neighbor region of the primary region as a function of the primary address.

30. The integrated circuit of claim 29, wherein the function provides a calculated address to a different memory channel from a memory channel of the primary address.

31. The integrated circuit of claim 30, wherein the function is based on the primary address and the regional granularity.

32. The integrated circuit of claim 31, wherein the function is further based on a number of interleaved channels and the channel interleave granularity.

33. An apparatus, comprising:
a memory; and
a controller communicatively coupled to the memory, the controller including circuitry to:
manage the memory in accordance with a page size and a channel interleave granularity,
store data in a primary region of the memory at a primary address, and
manage a mirror of the data in a secondary region of the memory at a secondary address at a regional granularity on demand at run time.

34. The apparatus of claim 33, wherein the circuitry is further to:
adjust a total amount of mirrored memory on demand at run time.

35. The apparatus of claim 33, wherein the circuitry is further to:
utilize a same number of interleaved ways for mirrored memory as a number of interleaved ways utilized for non-mirrored memory.

36. The apparatus of claim 33, wherein the circuitry is further to:
determine if the primary region is mirrored based on an indication stored in a page table entry.

37. The apparatus of claim 33, wherein the circuitry is further to:
calculate the secondary address to store the mirror of the data at an adjacent neighbor region of the primary region as a function of the primary address.

38. The apparatus of claim 37, wherein the function provides a calculated address to a different memory channel from a memory channel of the primary address.

39. The apparatus of claim 38, wherein the function is based on the primary address and the regional granularity.

40. The apparatus of claim 39, wherein the function is further based on a number of interleaved channels and the channel interleave granularity.

41. A method, comprising:
controlling a memory by a memory controller in accordance with a page size and a channel interleave granularity;
storing data in a primary region of the memory at a primary address; and
managing a mirror of the data in a secondary region of the memory at a secondary address at a regional granularity on demand at run time.

42. The method of claim 41, further comprising:
one or more of setting up, allocating, and freeing the secondary region of the memory for the mirror of the data on demand at run time.

43. The method of claim 41, wherein the regional granularity corresponds to a page granularity.

44. The method of claim 41, further comprising:
determining if the primary region is mirrored based on an indication stored in a page table entry.

45. The method of claim 41, further comprising:
calculating the secondary address to store the mirror of the data at an adjacent neighbor region of the primary region as a function of the primary address.
